(19) United States
(12) Patent Application Publication
(10) Pub. No.: US 2024/0256895 A1
(43) Pub. Date: Aug. 1, 2024

(54) METHOD AND DEVICE WITH FEDERATED LEARNING OF NEURAL NETWORK WEIGHTS

(71) Applicants: SAMSUNG ELECTRONICS CO., LTD., Suwon-si (KR); Korea Advanced Institute of Science and Technology, Daejeon (KR)

(72) Inventors: Jonghoon YOON, Suwon-si (KR); Geon PARK, Daejeon (KR); Jaehong YOON, Daejeon (KR); Sung Ju HWANG, Daejeon (KR); Wonyong JEONG, Daejeon (KR)

(73) Assignees: SAMSUNG ELECTRONICS CO., LTD., Suwon-si (KR); Korea Advanced Institute of Science and Technology, Daejeon (KR)

(21) Appl. No.: 18/343,073

(22) Filed: Jun. 28, 2023

(30) Foreign Application Priority Data
Jan. 30, 2023 (KR) 10-2023-0012106

(51) Int. Cl. G06N 3/098; G06N 3/045

(52) U.S. Cl. CPC G06N 3/098; G06N 3/045

(57) ABSTRACT

A method and device with federated learning of neural network models are disclosed. A method includes: receiving weights of respective clients, wherein each weight has a respectively corresponding precision that is initially an inherent precision; using a dequantizer to change the weights such that the precisions thereof are changed from the inherent precisions to a same reference precision; determining masks respectively corresponding to the weights based on the inherent precisions; based on the masks, determining an integrated weight by merging the weights having the reference precision; and quantizing the integrated weight to generate quantized weights having the inherent precisions, respectively, and transmitting the quantized weights to the clients.

### CROSS-REFERENCE TO RELATED APPLICATIONS

This application claims the benefit under 35 USC § 119(a) of Korean Patent Application No. 10-2023-0012106 filed on Jan. 30, 2023, in the Korean Intellectual Property Office, the entire disclosure of which is incorporated herein by reference for all purposes.

### BACKGROUND

### 1. Field

The following description relates to a method and device with federated learning of neural network weights.

### 2. Description of Related Art

An on-device environment or performing federated learning between portable embedded devices may involve federated learning even between devices having operations or memories of different numeric precisions, e.g., in terms of hardware. However, such federated learning between different precision-based devices may degenerate a distribution of model weights and degrade performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method, includes: receiving weights of respective clients, wherein each weight has a respectively corresponding precision that is initially an inherent precision; using a dequantizer to change the weights such that the precisions thereof are changed from the inherent precisions to a same reference precision; determining masks respectively corresponding to the weights based on the inherent precisions; based on the masks, determining an integrated weight by merging the weights having the reference precision; and quantizing the integrated weight to generate quantized weights having the inherent precisions, respectively, and transmitting the quantized weights to the clients.

The dequantizer may include blocks, and each of the blocks may have an input precision and an output precision.

The changing may include inputting each of the weights to whichever of the blocks has an input precision that matches its inherent precision, and obtaining an output of whichever of the blocks has an output precision that matches the reference precision.

The determining of the masks may include obtaining a statistical value of first weights, among the weights, which have an inherent precision greater than or equal to a preset threshold precision among the weights, and determining the masks based on the statistical value.

The determining of the masks based on the statistical value may include: for each of second weights of which an inherent precision is less than the statistical value among the weights, obtaining a similarity thereof to the statistical value; and determining masks respectively corresponding to the second weights based on the similarities.

The determining of the masks respectively corresponding to the second weights may include: determining a binary mask that maximizes the similarities of the respective second weights.

The method may further include training the dequantizer on a periodic basis.

The dequantizer may include: blocks, wherein the training of the dequantizer may include: receiving learning weight data; generating pieces of quantized weight data by quantizing the learning weight data; obtaining, for each of the blocks, a first loss that is determined based on a difference between intermediate output weight data predicted from a block and quantized weight data corresponding to the block; obtaining a second loss that is determined based on a difference between final output weight data output from the dequantizer receiving the learning weight data and true weight data corresponding to the learning weight data; and training the dequantizer based on the first loss and the second loss.

The receiving of the weights may include: receiving the weights of individually trained neural network models from the clients.

A non-transitory computer-readable storage medium may store instructions that, when executed by a processor, cause the processor to perform any of the methods.

In another general aspect, an electronic device includes: one or more processors; a memory storing instructions configured to cause the one or more processors to: receive weights of clients, wherein the weights have respectively corresponding precisions that are initially inherent precisions; dequantize the weights such that the precisions thereof are changed from the inherent precisions to a same reference precision; determine an integrated weight by merging the weights changed to have the reference precision; and quantize the integrated weight to weights respectively having the inherent precisions and transmit the quantized weights to the clients.

The dequantizing may be performed by a dequantizer including blocks, wherein each of the blocks may have an input precision corresponding to at least one of the inherent precisions and may have an output precision corresponding to at least one of the inherent precisions.

The instructions may be further configured to cause the one or more processors to: input each of the weights to whichever of the blocks has an input precision corresponding to the weight's inherent precision; and obtain an output of whichever of the blocks has an output precision corresponding to the reference precision.

The instructions may be further configured to cause the one or more processors to: obtain a statistical value of first weights selected from among the weights based on having an inherent precision greater than or equal to a preset threshold precision; and determine masks based on the statistical value, wherein the merging is based on the weights.

The instructions may be further configured to cause the one or more processors to: obtain a similarity to the statistical value for each of second weights, among the weights, having an inherent precision that is less than the preset threshold precision; and determine masks respectively corresponding to the second weights based on the similarity.

The instructions may be further configured to cause the one or more processors to determine a binary mask that maximizes the similarity of each of the second weights.

The instructions may be further configured to cause the one or more processors to periodically train a dequantizer that performs the dequantizing.

The dequantizer may include: blocks, wherein the instructions may be further configured to cause the one or more processors to: receive learning weight data; generate pieces of quantized weight data by quantizing the learning weight data; obtain a first loss that is determined based on a difference between intermediate output weight data predicted from a block and quantized weight data corresponding to the block, for each of the plurality of blocks; and obtain a second loss that is determined based on a difference between final output weight data output from the dequantizer receiving the learning weight data and true weight data corresponding to the learning weight data; and train the dequantizer based on the first loss and the second loss.

The weights received from the clients may be weights of neural network models individually trained by the clients.

Other features and aspects will be apparent from the following detailed description, the drawings, and the claims.

### BRIEF DESCRIPTION OF THE DRAWINGS

FIG. 1 illustrates an example of a federated learning system according to one or more example embodiments.

FIG. 2 illustrates an example of a federated learning method, according to one or more example embodiments.

FIG. 3 illustrates an example of a federated learning system, according to one or more example embodiments.

FIG. 4 illustrates an example of changing the precision of a weight using a dequantizer and training the dequantizer, according to one or more example embodiments.

FIG. 5 illustrates an example of selective weight integration, according to one or more example embodiments.

FIG. 6 illustrates an example flow of operations of a server, according to one or more example embodiments.

FIG. 7 illustrates an example flow of operations of a client, according to one or more example embodiments.

FIG. 8 illustrates an example of a federated learning method using a progressive weight dequantizer for a meta-learning algorithm, according to one or more example embodiments.

FIG. 9 illustrates an example configuration of an electronic device, according to one or more example embodiments.

Throughout the drawings and the detailed description, unless otherwise described or provided, the same drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

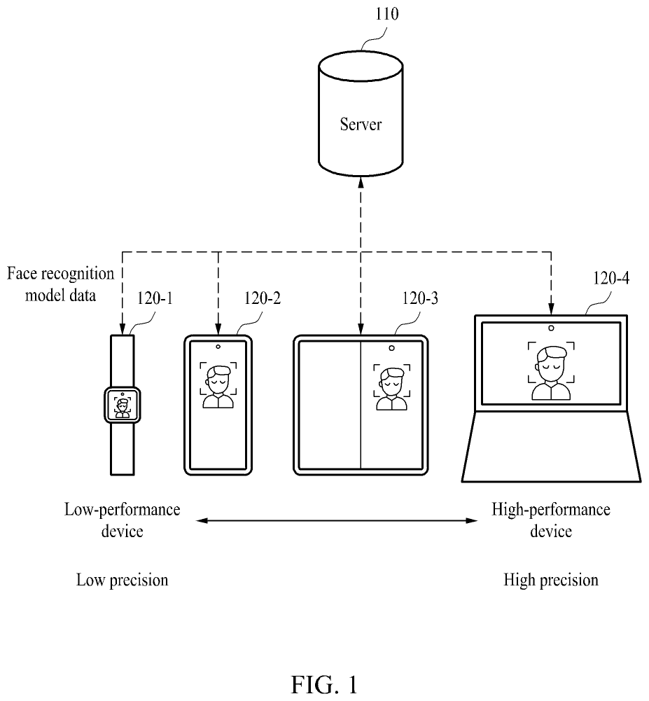

FIG. 1 illustrates an example of a federated learning system according to one or more example embodiments. A federated learning system may include a server 110 and clients (e.g., a first client 120-1, a second client 120-2, a third client 120-3, and a fourth client 120-4). The clients are not limited to the illustrated first through fourth clients 120-1 through 120-4 and may vary or be adopted in various ways.

The server 110 may be connected to each of the clients through a network. The network may include, for example, the Internet, one or more local area networks (LANs) and wide area networks (WANs), a cellular network, a mobile network, other types of networks, or combinations of these networks. Techniques described herein may also be applied to non-networked implementations. For example, a single device might use different neural networks for different parameters of a same objective.

A client described herein may provide a service to a user based on a neural network model implemented in the client (and possibly trained by the client). The service provided by the client based on the neural network model may be referred to as an artificial intelligence (AI) service. For example, the client may be a terminal that provides an AI-based face recognition service. The client may also be referred to as a local device or a user terminal. A terminal may be any digital device including a memory means and a microprocessor and having a computation capability, such as, for example, a wearable device, a personal computer (PC, e.g., a laptop computer, etc.), a tablet (PC), a smartphone, a smart television (TV), a mobile phone, a navigation device, a web pad, a personal digital assistant (PDA), a workstation, or the like. However, types of the client are not limited to the foregoing examples, and the client may include various electronic devices (e.g., an Internet of things (IoT) device, a medical device, an autonomous driving device, etc.) that provide AI services.

The clients may provide AI services by each constructing or storing its own different neural network model that based on different respective data. In other words, the clients may have different neural network models based on different client data, for example, and may provide different AI services. For example, the first client 120-1 may provide a face recognition service with a first neural network model and the second client 120-2 may provide a fingerprint recognition service with a second neural network model (e.g., with different weights of different precision than the first model). Alternatively, the clients may construct their respective artificial neural network models based on different data even though they provide the same AI service (e.g., the face recognition service). Of note is that different clients may have different neural network models (in some cases, of a same network architecture but with different weights, parameters, precisions, etc.)

The clients may have different hardware specifications (or performance capabilities), based on which they may be set with different precisions of numeric representations (primitives) and computations. That is, the clients may have operations or memories of different precisions in terms of hardware. For example, different clients may have different precisions in that they have different bitwidths. For example, some clients may implement int32 primitives, others may implement int8 primitives. Some clients may have floating point primitives of different precisions.

For example, the first client 120-1 may have a device-specific precision of int4, the second client 120-2 may have a device-specific precision of int8, the third client 120-3 may have a device-specific precision of int16, and the fourth client 120-4 may have a device-specific precision of float32. A precision of int n represents 2ⁿ integers. A precision of float16 may use 1 bit for representing a sign, 5 bits for representing an integer part, and 10 bits for representing a fractional part, and a precision of float32 may indicate a precision that uses 1 bit for representing a sign, 8 bits for representing an integer part, and 23 bits for representing a fractional part. Various types of numeric primitives of varying precision are known and techniques described herein may be used with any numeric primitives that have different precisions.

The server 110 may receive weights of respective trained neural network models from the clients and the weights may have different respective precisions, for example, because the clients may have hardware (e.g., word sizes and/or arithmetic logic units) with different precisions. For example, one model may have int4 weights and another might have float32 weights. The server 110 may generate an integrated weight, and transmit the generated integrated weight to the clients. The integrated weight may be a combination of the weights from the clients, which may be combined in various ways. In this case, simply merging a low-precision model weight with a high-precision weight may not maintain a high-precision model accuracy due to a difference in a weight value distribution. “Weight” as used herein refers to a sets of weights of a neural network model. That is a “weight” is a set of weights of nodes of a neural network. Similarly, “weights” refers to sets of weights of respective neural network models.

As described in detail below, the server 110 may receive weights having different precisions and convert each of the weights to a respective weight having a specific precision using a dequantizer. A “precision” of a weight of a neural network refers to the precision of the weights of the nodes in the weight, which may be changed. Hereinafter, a precision that is used when each of the clients trains an artificial neural network model and performs inference will be referred to as an inherent precision (i.e., an original precision), and a precision of a weight obtained through a conversion by the server 110 will be referred to as a reference precision. The server 110 may perform federated learning by communicating with through a bandwidth (e.g., a network bandwidth) that is tens of times lower through quantization, and may avoid exposing private data (data inferenced by a neural network model) by transmitting a learned model weight without transmitting input data thereto.

Face recognition, which is an AI-applied technology generally requiring a great amount of learning/training data, may use face data that is closely associated with an individual's private life. Thus, in the past, even when there was a great amount of face data scattered in a wide range of devices requiring face recognition, for example, from smartwatches and smartphones to laptops, it may not have been possible to improve a face recognition model by collecting such a large amount of face data.

However, using a federated learning system according to examples and embodiments described herein, each local face recognition model (or other type of model) may be trained with a precision corresponding to a specification (or performance) of each respective client (e.g., the first through fourth clients 120-1 through 120-4) and then only a weight of the model may be exchanged. A federated learning system may therefore reduce or minimize privacy concerns and may obtain quantized models suitable for hardware specifications (or performances) of the respective devices.

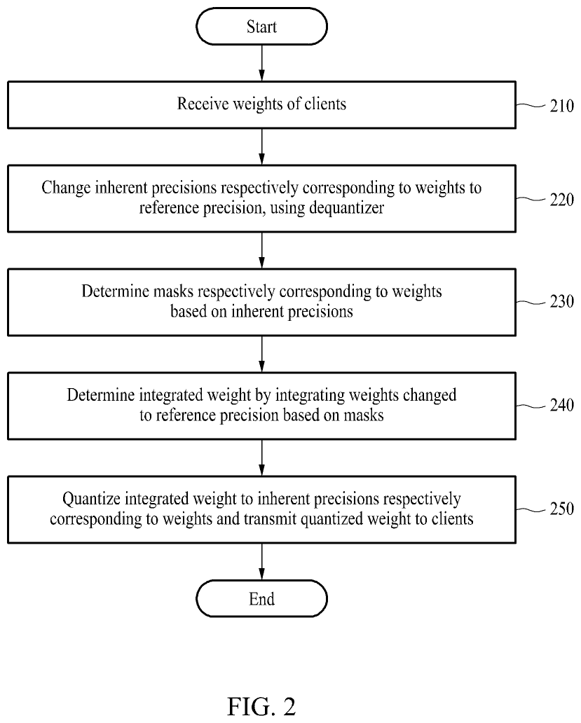

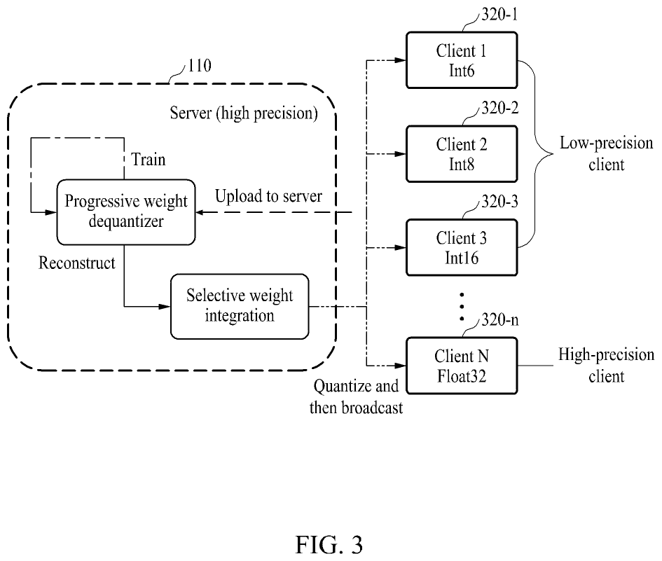

FIGS. 2 and 3 illustrate an example of a federated learning method according to one or more example embodiments. What has been described above with reference to FIG. 1 is applicable to the example of FIGS. 2 and 3. Moreover, for convenience, operations 210 through 250 described below may be performed using the server 110 described above with reference to FIG. 1. However, operations 210 through 250 may also be used in any suitable systems through any suitable electronic devices. For example, the operations may be performed by a cloud service, a controller of Internet of Things nodes, etc. Further, although the operations of FIG. 2 may be performed in the illustrated order, some of the operations may be performed in a different order or omitted.

In operation 210, the server 110 may receive weights of respective clients. Each of the clients may transmit to the server 110 a respective weight having a respective inherent precision, and, as discussed above, some of the weights may have different precisions.

Referring to FIG. 3, a first client 320-1 may transmit a weight of int6 inherent precision, a second client 320-2 may transmit a weight of int8 inherent precision, a third client 320-3 may transmit a weight of int16 inherent precision, and an nth client 320-n may transmit a weight of float32 inherent precision; the weights may be transmitted to the server 110.

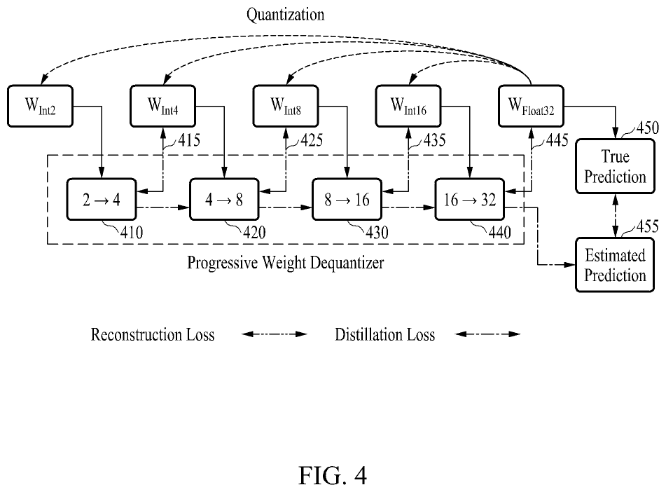

In operation 220, the server 110 may use a dequantizer to change the precisions of the weights from their inherent precisions to each have a same reference precision. That is, each weight may be dequantized from its original/inherent precision to the common reference precision. In some examples, the dequantizer may be a progressive weight dequantizer. The dequantizer, which is present in (or called from) the server 110, may be a neural network model that predicts a low-bit weight to be a progressively high-bit weight. A low-bit weight refers to a weight with a relatively low precision, and a high-bit weight refers to a weight with a relatively high precision (“high” and “low” are relative terms and represent any types of varying-precision primitives). The server 110 may periodically train the dequantizer using a received high-precision weight. A method of changing a weight's precision using the dequantizer and a method of training the dequantizer are described with reference to FIG. 4.

In operation 230, the server 110 may determine masks respectively corresponding to the weights based on the inherent precisions thereof. In operation 240, the server 110 may determine an integrated weight by merging (or integrating) the weights as changed (dequantized) to the reference precision.

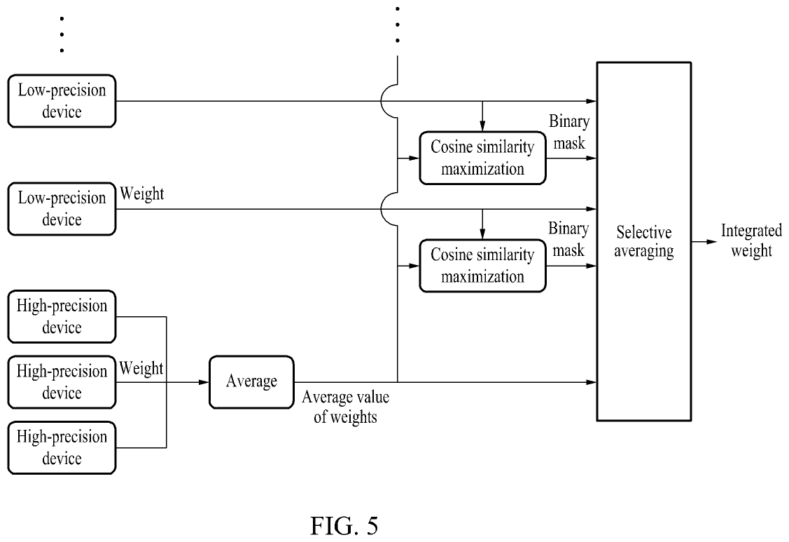

For example, regarding the aforementioned integration, referring to FIG. 3, the server 110 may selectively merge learned weights through the dequantizer to minimize negative interference between weights of different bits and achieve high performance. The server 110 may use a selective weight integration method for reconstructed high-precision weights to generate a single high-precision weight. A selective weight integration method is described with reference to FIG. 5.

In operation 250, the server 110 may quantize the integrated weight to weights with precisions corresponding to the original inherent precisions (of the weights from the clients) and transmit the quantized weight to the clients.

For example, referring to FIG. 3, the server 110 may quantize a merged high-precision weight (hereinafter, an integrated weight) according to a hardware precision of each client and broadcast the quantized weight. For example, the server 110 may quantize the integrated weight to int6 precision and broadcast the int6 precision weight to the first client 320-1, quantize the integrated weight to int8 precision and broadcast the int8 precision weight to the second client 320-2, quantize the integrated weight to int16 precision and broadcast the int16 precision weight to the third client 320-3, and quantize the integrated weight to float32 precision and broadcast the float32 precision weight to the nth client 320-n. Each client may apply, to its local model, a quantized weight (received from the server 110) that may be specific to the client.

FIG. 4 illustrates an example of changing the precision of a weight using a dequantizer and training the dequantizer according to one or more example embodiments. Descriptions above with reference to FIGS. 1 through 3 are generally applicable to the example of FIG. 4.

Referring to FIG. 4, a dequantizer may include blocks (e.g., a first block 410, a second block 420, a third block 430, and a fourth block 440) although the number of blocks is not limited thereto and may vary according to the implementation.

In an example, each block may have an input precision and an output precision. For example, the first block 410 may change a weight of int2 precision to a weight of int4 precision, the second block 420 may change a weight of int4 precision to a weigh of int8 precision, the third block 430 may change a weight of int8 precision to a weight of int16 precision, and the fourth block 440 may change a weight of int16 precision to a weight of float32 precision. However, the input precisions and the output precisions of the blocks are not limited to the foregoing examples but may vary according to the implementation.

A set of various precisions, for example hardware precisions of k types of devices participating in federated learning, may be Π={π₀, . . . , πₖ}, in which values of πᵢ are in ascending order. A dequantizer function may be, for example, ϕ=ϕ^{π}^{₀}^{→π}^{ₖ}=ϕ^{π}^{₀}^{→π}^{₁}∘ϕ^{π}^{₁}^{→π}^{₂}∘ . . . ∘ϕ^{ϕ}^{ₖ₋₁}^{→π}^{ₖ}. In this equation, ϕ^{π}^{ᵢ}^{→π}^{ᵢ₊₁} denotes a block that converts a πᵢ bit weight to a πᵢ₊₁ bit weight, and ∘ denotes a concatenation operator.

Each block may be implemented as a neural network h(⋅; θ) that preserves a dimension of a weight tensor. 6 denotes a parameter of the artificial neural network. For example, when receiving a πⱼ bit weight value w from a client, the dequantizer may quantize the weight values of w to from π₀ bits to πⱼ₋₁ bits to obtain j weight values, i.e., Q_{w}={q_{π}_{₀}, . . . , q_{π}_{_{j−1}}}. An operation of converting these values to a higher-precision weight \hat{q}_{π}_{_{j−1}} is expressed by Equation 1 below.

$${\hat{q}}_{{π}_{j + 1}} = {ϕ}^{{π}_{j}} ( {q}_{{π}_{j}} ; {θ}_{j} ) = {q}_{{π}_{j}} + h ( {q}_{{π}_{j}} ; {θ}_{j} ) \qquad Equation 1$$

In Equation 1, w may be used by dividing the received weight tensor into a preset dimension (or size). The dequantizer may be trained based on a first loss function and a second loss function. The first loss function may also be referred to as a reconstruction loss function [symbol] , and the second loss function may also be referred to as a distillation loss function [symbol] . The reconstruction loss function may numerically express how close an approximate weight is to an actual high bitwidth using a distance L1, as expressed by Equation 2.

$${ℒ}_{recon} = {\sum }_{j = 0}^{k - 1} {‖ {q}_{{π}_{j + 1}} - {ϕ}^{{π}_{j} \to {π}_{j + 1}} ( {q}_{{π}_{j}} ; {θ}_{j} ) ‖}_{1} \qquad Equation 2$$

In Equation 2, learning data may use weight values of the highest precision among weights received from local devices. For example, the server 110 may receive W_{Float32} as the learning data, and quantize the received W_{Float32} to generate quantized weight data Wᵢₙₜ₂, Wᵢₙₜ₄, Wᵢₙₜ₈, and Wᵢₙₜ₁₆. In this example, the first block 410 may receive the quantized Wᵢₙₜ₂ and output a weight having int4 precision. A reconstruction loss 415 corresponding to the first block 410 may be determined based on a difference between Wᵢₙₜ₄ and the weight having int4 precision that is converted by the first block 410. A reconstruction loss 425 corresponding to the second block 420 may be determined based on a difference between Wᵢₙₜ₈ and a weight having int8 precision that is converted by the second block 420. A reconstruction loss 435 corresponding to the third block 430 may be determined based on a difference between Wᵢₙₜ₁₆ and a weight having int16 precision that is converted by the third block 430. A reconstruction loss 445 corresponding to the fourth block 440 may be determined based on a difference between W_{float32} and a weight having float32 precision that is converted by the fourth block 440.

When the same input is provided, the distillation loss function may calculate how closely a network output of a reconstructed weight approximates a network output of an actual weight, using a small data buffer [symbol] stored in the server 110, as expressed by Equation 3.

$${ℒ}_{distill} = - Sim ( f ( u ; w ) , f ( u ; {ϕ}^{0 \to k} ( {q}_{{π}_{0}} ; Θ ) ) ) \qquad Equation 3$$

In Equation 3, Sim(⋅,⋅) denotes a cosine similarity between two values, f(u;w) denotes an output value when u is input as an input to a network having a weight w, and Θ={θ₀, . . . , θₖ} denotes a set of parameters of each block of the dequantizer. For example, a distillation loss may be determined based on a difference between final output weight data 455 that is output from the dequantizer based on the dequantizer receiving Wᵢₙₜ₂ and true weight data 450 corresponding to learning weight data. A final loss function may use a function, as expressed by Equation 4 below, in which the two loss functions are combined.

$$ℒ = {ℒ}_{recon} + {λℒ}_{distill} \qquad Equation 4$$

In Equation 4, λ denotes a scalar value that balances the two loss functions. The dequantizer may be updated periodically during a federated learning process by using newly obtained weights as learning data. The server 110 may adjust parameters of each block of the dequantizer through backpropagation such that the loss function determined based on Equation 4 is minimized.

The dequantizer that has been trained may reconstruct a low-precision weight of a neural network to a high-precision weight. For example, when an int2 reference weight is received from a client and a reference precision is float32, the dequantizer may input the corresponding weight to the first block 410 and obtain an output of float32 precision of the fourth block 440. Similarly, when an int8 reference weight is received from a client, the dequantizer may input the corresponding weight to the second block 420 and obtain an output of float32 precision of the fourth block 440. The dequantizer may have units of blocks that reconstruct a low-precision weight of an artificial neural network to a high-precision weight and may thus change various inherent precisions to the reference precision.

FIG. 5 illustrates an example of selective weight integration according to one or more example embodiments. Descriptions with reference to FIGS. 1 through 4 are generally applicable to the example of FIG. 5.

Referring to FIG. 5, a server may measure a similarity between different bit (different precision) weights and remove a low-bit weight part having a low similarity to a high-bit weight before merging (or integration), thereby preventing negative bit interference that may occur during simple merging (or integration).

The server may determine an integrated weight by applying a mask to weights that have been changed to a reference precision. Such a mask may be determined based on a confidence score of an inherent precision. For example, a weight having a high precision (e.g., W_{float32}) may be determined to have a higher confidence score than a weight having a low precision (e.g., Wᵢₙₜ₄). Accordingly, when determining the integrated weight, the server may determine a mask that may increase (by masking selection) a proportion of high-precision weights (e.g., W_{float32}) rather than a proportion of low-precision weights (e.g., Wᵢₙₜ₄). The server may determine a weight having a precision higher than a preset reference to be a first weight, and a weight lower than a statistical value (e.g., an average) of the first weight to be a second weight.

For example, the server may determine weights having an inherent precision that is greater than or equal to a preset threshold precision among the weights to be first weights, obtain a statistical value of the first weights, and determine masks based on the statistical value. In this example, whether a precision is high or low may be determined by the length of a bitwidth. For example, W_{float32} (32 bitwidth) may be determined to have a higher precision than Wᵢₙₜ₄ (4 bitwidth).

Alternatively, the server may determine weights having an inherent precision that is included in the top N ranked weights to be first weights, obtain a statistical value of the first weights, and determine masks based on the statistical value. For example, the server may determine weights having the highest inherent precision to be the first weights.

For example, it is assumed below that the first weights are weights having the highest inherent precision, and the second weights are weights lower than a statistical value (e.g., an average) of the first weights. Other methods of determining the first weight and the second weight may be used.

For example, w̅_{High}^{(r)} and w̅_{Low}^{(r)} may be an average of weights (i.e., the first weights) having the highest precision received from local devices on a round r, and weights (i.e., the second weights) having a precision lower than the average, respectively, and they may be defined as Δw̅_{High}=w̅_{High}^{(r)}−w̅_{High}^{(r-1)} and Δw̅_{Low}=w̅_{Low}^{(r)}−w̅_{Low}^{(r-1)}.

In this example, for a second weight, a binary mask c may be calculated as expressed by Equation 5.

$$c = {argmax}_{c ϵ {\{ 0 , 1 \}}^{{N}_{e}}} \frac{{( c ⊙ Δ {\overline{w}}_{L o w} )}^{T} Δ {\overline{w}}_{H i g h}}{‖ c ⊙ Δ {\overline{w}}_{L o w} ‖ ‖ Δ {\overline{w}}_{H i g h} ‖} s . t . \frac{{‖ c ‖}_{0}}{{N}_{e}} < τ \qquad Equation 5$$

In Equation 5, ⊙ denotes a multiplication of elements (e.g., Hadamard product), Nₑ denotes a total number of elements of a weight vector, and T denotes a ratio of 1 in a binary mask. Subsequently, weight integration may be performed according to Equation 6. According to Equation 6, the binary mask may be a binary mask that maximizes a similarity of each second weight.

$${w}_{G} = \frac{1}{M} ⊙ {\sum }_{n = 1}^{N} {c}_{n} ⊙ {w}_{n} \qquad Equation 6$$

In Equation 6, cₙ denotes a binary mask of an nth local device, M=Σₙ₌₁^{N}cₙ, N denotes the number of all local devices, and wₙ denote a weight received from the nth local device.

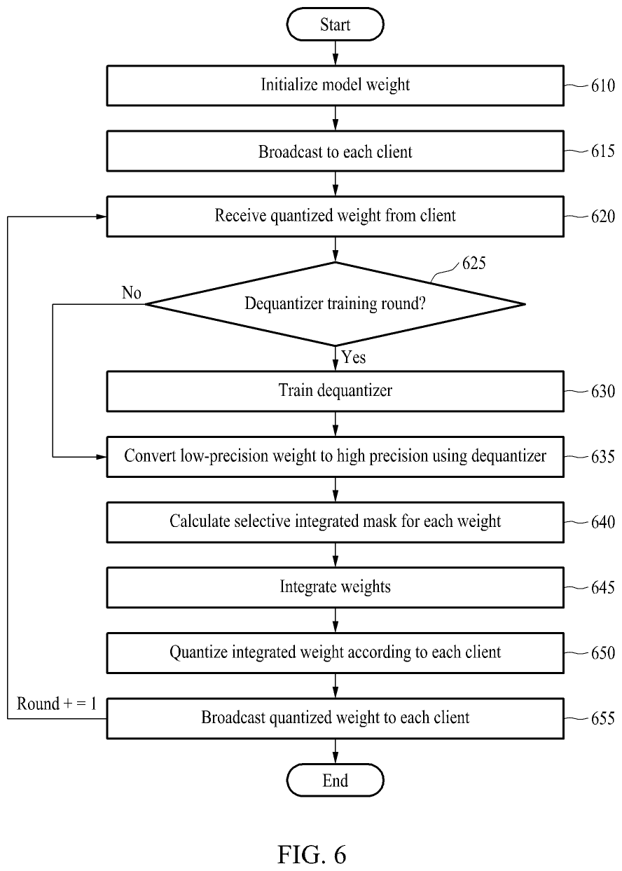

FIG. 6 illustrates an example flow of operations of a server according to one or more example embodiments.

What has been described above with reference to FIGS. 1 through 5 is generally applicable to the example of FIG. 6.

For convenience, operations 610 through 655 to be described below with reference to FIG. 6 may be performed using the server 110 described above with reference to FIG. 1. However, operations 610 through 655 may also be used in any suitable systems through any suitable electronic devices.

Further, although the operations of FIG. 6 may be performed in an illustrated order and way, some of the operations may be performed in a different order or omitted without departing from the idea and scope of the example embodiments of the present disclosure. Most of the operations of FIG. 6 may be performed simultaneously or in parallel.

In operation 610, the server 110 may initialize a weight of a global model to a random value. In operation 615, the server 110 may broadcast the initialized weight of the global model as an initial value to all clients. In operation 620, the server 110 may receive a quantized weight from a client.

As described above, the server 110 may train a dequantizer on a periodic basis. In operation 625, the server 110 may determine whether a current round is a dequantizer training round.

In operation 630, in response to a determination that the current round is a dequantizer training round, the server 110 may train the dequantizer. In operation 635, the server 110 may convert a weight of an inherent precision (e.g., low precision) to a weight of a reference precision (e.g., high precision) using the dequantizer. In response to a determination that the current round is not the dequantizer training round, the server 110 may omit operation 630.

In operation 640, the server 110 may calculate a selective integrated mask for each weight. In operation 645, the server 110 may determine an integrated weight using the mask.

In operation 650, the server 110 may quantize the integrated weight according to each client. In operation 655, the server 110 may broadcast the quantized weight to each client. After increasing the current round by one step, the server 110 may repeat operations 620 through 655 until they converge.

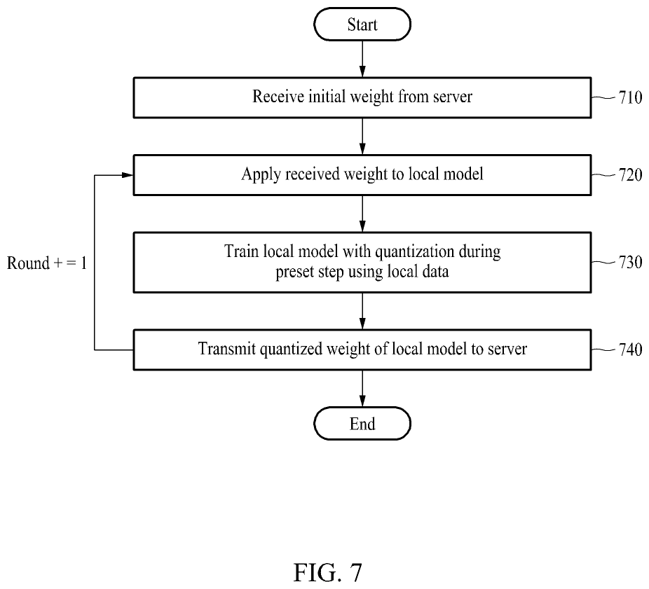

FIG. 7 illustrates an example flow of operations of a client according to one or more example embodiments.

The descriptions with reference to FIGS. 1 through 6 are generally applicable to the example of FIG. 7.

For the convenience of description, operations 710 through 740 (described below with reference to FIG. 7) may be performed using a client described above with reference to FIG. 1. However, operations 710 through 740 may also be used in any suitable systems through any suitable electronic devices.

Further, although the operations of FIG. 7 may be performed in an illustrated order and way, some of the operations may be performed in a different order or omitted without departing from the idea and scope of the example embodiments of the present disclosure. Most of the operations of FIG. 7 may be performed simultaneously or in parallel.

In operation 710, a client may receive an initial weight from a server.

In operation 720, the client receiving the initial weight may apply the received weight to a local model (e.g., a neural network model). In operation 730, the client may train the local model with a low precision using a method such as stochastic gradient descent (SGD) by a predetermined number of steps using local data (e.g., using photo/video data collected by the client).

In operation 740, the client may transmit a quantized weight of the local model to the server. After increasing a current round by one step, the client may repeat operations 720 through 740 until they converge.

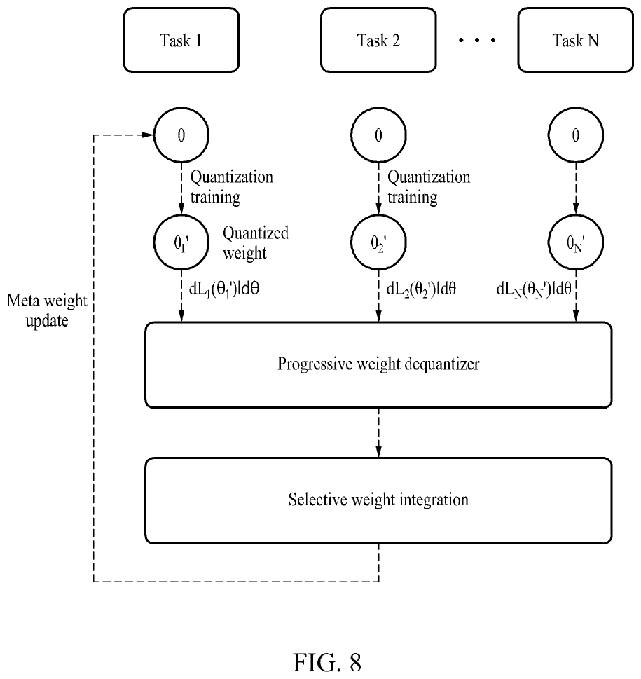

FIG. 8 illustrates an example of a federated learning method using a progressive weight dequantizer for a meta-learning algorithm according to one or more example embodiments.

Referring to FIG. 8, meta learning may be an algorithm for finding a meta weight that increases the generalization performance through fast adaptation to various tasks. However, it may use a great amount of time for training because it needs to train an artificial neural network model for various tasks simultaneously.

Thus, distributing a computational precision according to a difficulty of each task and performing quantization learning may reduce the training time significantly. To merge or integrate weight gradients of different precisions, a progressive weight dequantizer and a selective weight integration method may be applied.

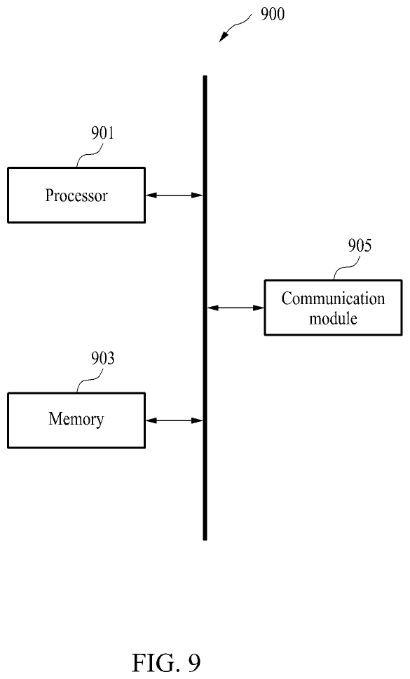

FIG. 9 illustrates an example configuration of an electronic device according to one or more example embodiments.

Referring to FIG. 9, an electronic device 900 may include a processor 901, a memory 903, and a communication module 905. In an example, the electronic device 900 may be, or may be included in, the server described above with reference to FIGS. 1 through 7.

In an example, the processor 901 may perform at least one of the operations described above with reference to FIGS. 1 through 7. For example, the processor 901 may receive weights of a plurality of clients, change inherent precisions respectively corresponding to the weights to a reference precision using a dequantizer, determine masks respectively corresponding to the weights based on the inherent precisions, determine an integrated weight by merging (or integrating) the weights changed to the reference precision based on the masks, and quantize the integrated weight to inherent precisions respectively corresponding to the weights and transmit the quantized weight to the clients.

The memory 903 may be a volatile or non-volatile memory and may store data relating to the federated learning method described above with reference to FIGS. 1 through 7. In an example, the memory 903 may store the weights received from the clients or data necessary to perform federated learning.

The communication module 905 may provide a function for the device 900 to communicate with other electronic devices or other servers through a network. That is, the device 900 may be connected to an external device (e.g., a client or a network) through the communication module 905 and exchange data therewith. For example, the device 900 may transmit and receive, through the communication module 905, data and a database (DB) in which learning data sets for federated learning are stored.

In an example, the memory 903 may store a program (instructions) that implements the federated learning method described above with reference to FIGS. 1 through 7. The processor 901 may execute the program stored in the memory 903 to control the device 900, and code of the program executed by the processor 901 may be stored in the memory 903.

In an example, the device 900 may further include other components that are not shown. The device 900 may further include, for example, an input/output interface including an input device and an output device as a means for interfacing with the communication module 905. In addition, the device 900 may further include other components, such as, for example, a transceiver, various sensors, and a DB.

The computing apparatuses, the electronic devices, the processors, the memories, the information output system and hardware, the storage devices, and other apparatuses, devices, units, modules, and components described herein with respect to FIGS. 1-9 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-9 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method, comprising:
receiving weights of respective clients, wherein each weight has a respectively corresponding precision that is initially an inherent precision;
using a dequantizer to change the weights such that the precisions thereof are changed from the inherent precisions to a same reference precision;
determining masks respectively corresponding to the weights based on the inherent precisions;
based on the masks, determining an integrated weight by merging the weights having the reference precision; and
quantizing the integrated weight to generate quantized weights having the inherent precisions, respectively, and transmitting the quantized weights to the clients.

2. The method of claim 1, wherein the dequantizer comprises:
blocks,
wherein each of the blocks has an input precision and an output precision.

3. The method of claim 2, wherein the changing comprises:
inputting each of the weights to whichever of the blocks has an input precision that matches its inherent precision; and
obtaining an output of whichever of the blocks has an output precision that matches the reference precision.

4. The method of claim 1, wherein the determining of the masks comprises:
obtaining a statistical value of first weights, among the weights, which have an inherent precision greater than or equal to a preset threshold precision among the weights; and
determining the masks based on the statistical value.

5. The method of claim 4, wherein the determining of the masks based on the statistical value comprises:
for each of second weights of which an inherent precision is less than the statistical value among the weights, obtaining a similarity thereof to the statistical value; and
determining masks respectively corresponding to the second weights based on the similarities.

6. The method of claim 5, wherein the determining of the masks respectively corresponding to the second weights comprises:
determining a binary mask that maximizes the similarities of the respective second weights.

7. The method of claim 1, further comprising:
training the dequantizer on a periodic basis.

8. The method of claim 7, wherein the dequantizer comprises:
blocks,
wherein the training of the dequantizer comprises:
receiving learning weight data;
generating pieces of quantized weight data by quantizing the learning weight data;
obtaining, for each of the blocks, a first loss that is determined based on a difference between intermediate output weight data predicted from a block and quantized weight data corresponding to the block;
obtaining a second loss that is determined based on a difference between final output weight data output from the dequantizer receiving the learning weight data and true weight data corresponding to the learning weight data; and
training the dequantizer based on the first loss and the second loss.

9. The method of claim 1, wherein the receiving of the weights comprises:
receiving the weights of individually trained neural network models from the clients.

10. A non-transitory computer-readable storage medium storing instructions that, when executed by a processor, cause the processor to perform the method of claim 1.

11. An electronic device comprising:
one or more processors;
a memory storing instructions configured to cause the one or more processors to:
receive weights of clients, wherein the weights have respectively corresponding precisions that are initially inherent precisions;
dequantize the weights such that the precisions thereof are changed from the inherent precisions to a same reference precision;
determine an integrated weight by merging the weights changed to have the reference precision; and
quantize the integrated weight to weights respectively having the inherent precisions and transmit the quantized weights to the clients.

12. The electronic device of claim 11, wherein the dequantizing is performed by a dequantizer comprising blocks, wherein each of the blocks has an input precision corresponding to at least one of the inherent precisions and has an output precision corresponding to at least one of the inherent precisions.

13. The electronic device of claim 12, wherein the instructions are further configured to cause the one or more processors to:
input each of the weights to whichever of the blocks has an input precision corresponding to the weight's inherent precision; and
obtain an output of whichever of the blocks has an output precision corresponding to the reference precision.

14. The electronic device of claim 11, wherein the instructions are further configured to cause the one or more processors to:
obtain a statistical value of first weights selected from among the weights based on having an inherent precision greater than or equal to a preset threshold precision; and
determine masks based on the statistical value, wherein the merging is based on the weights.

15. The electronic device of claim 14, wherein the instructions are further configured to cause the one or more processors to:
obtain a similarity to the statistical value for each of second weights, among the weights, having an inherent precision that is less than the preset threshold precision; and
determine masks respectively corresponding to the second weights based on the similarity.

16. The electronic device of claim 15, wherein the instructions are further configured to cause the one or more processors to:
determine a binary mask that maximizes the similarity of each of the second weights.

17. The electronic device of claim 11, wherein the instructions are further configured to cause the one or more processors to: periodically train a dequantizer that performs the dequantizing.

18. The electronic device of claim 17, wherein the dequantizer comprises:
blocks,
wherein the instructions are further configured to cause the one or more processors to:
receive learning weight data;
generate pieces of quantized weight data by quantizing the learning weight data;
obtain a first loss that is determined based on a difference between intermediate output weight data predicted from a block and quantized weight data corresponding to the block, for each of the plurality of blocks; and
obtain a second loss that is determined based on a difference between final output weight data output from the dequantizer receiving the learning weight data and true weight data corresponding to the learning weight data; and
train the dequantizer based on the first loss and the second loss.

19. The electronic device of claim 11, wherein the weights received from the clients are weights of neural network models individually trained by the clients.
